(19) United States
(12) Patent Application Publication
(10) Pub. No.: US 2020/0247325 A1
(43) Pub. Date: Aug. 6, 2020

(54) ROOF RACK FOR VEHICLE

(71) Applicant: LG Hausys, Ltd., Seoul (KR)

(72) Inventors: Yong-Woo JUNG, Seoul (KR); Ju-Hyun KWON, Seoul (KR); Yong-Han KANG, Seoul (KR); Wook-Hee LEE, Seoul (KR)

(21) Appl. No.: 16/652,224

(22) PCT Filed: Oct. 1, 2018
(86) PCT No.: PCT/KR2018/011628

§ 371 Date: Mar. 30, 2020

(30) Foreign Application Priority Data
Sep. 29, 2017 (KR) 10-2017-0126789

(51) Int. Cl. B60R 9/04

(52) U.S. Cl. CPC B60R 9/04

(57) ABSTRACT

A roof rack for a vehicle according an embodiment of the present invention comprises roof rails, and attaches to the body of a vehicle, wherein each roof rail has a hollow groove extending in the lengthwise direction, the bottom of the roof rail is open in the direction of attachment to the car body due to the hollow groove, the open bottom part of the roof rail is provided with ribs, and the ribs connect the side walls formed by the hollow groove.

### TECHNICAL FIELD

The present disclosure relates to a roof rack for a vehicle. More specifically, the present disclosure relates to a roof rack for a vehicle in which a rib is formed in a hollow groove defined in a bottom of a roof rail, thereby to prevent surface shrinkage and formation of a sink mark due to cooling after molding, and to easily couple a loop pad to the rib.

### BACKGROUND

In general, transport of cargo using a vehicle is carried out using a trunk of the vehicle. However, a bulky cargo or long cargo may not be transported using a trunk space but may be transported using a roof rack.

Moreover, the roof rack is fixed to a roof panel as a roof of the vehicle. A relatively bulky cargo such as camping equipment or leisure equipment such as skiing is loaded onto the roof rack. Nowadays, popularization of a vehicle for leisure (SUV; Sport Utility Vehicle, RV; recreational vehicle) and camping boom allow the roof rack to be widely used.

However, a roof rack according to a prior art is manufactured by high temperature extrusion molding of plastic for weight reduction, and thus is mounted on a vehicle. In this connection, there is a problem that bending or shape deformation due to shrinkage in the cooling process occurs, and a sink mark is formed.

### DISCLOSURE

### Technical Purpose

One purpose of the present disclosure is to provide a roof rack for a vehicle in which a roof rail is made of plastic material, and ribs as connectors are formed at an open bottom of the roof rail, such that the roof rail may be prevented from shrinking, and appearance quality defects caused by formation of a sink mark may be suppressed, and the roof rail has improved durability due to the ribs.

Another aspect of the present disclosure is to provide a roof rack for a vehicle in which a roof pad coupling portion is defined in a rib of the roof rail to allow easy coupling of a roof pad to the roof rail.

### Technical Solution

A first aspect of the present disclosure provides a roof rack for a vehicle, the roof rack comprising a roof rail to be coupled to a vehicle body, wherein the roof rail has a hollow groove defined therein to extending in a longitudinal direction thereof, wherein a bottom of the roof rail is open and communicates with the hollow groove, wherein the bottom of the roof rail is coupled to the vehicle body, wherein the roof rail has both side walls defining the hollow groove therebetween, wherein the roof rail has a rib formed at the open bottom of the roof rail such that the rib connects the both side walls to each other.

In one implementation of the first aspect, the rib includes a plurality of ribs spacedly arranged at an equal spacing in the longitudinal direction, wherein the ribs partially cover the hollow groove.

In one implementation of the first aspect, a width of each rib is a range of 0.5 mm to 50 mm, wherein a spacing between adjacent ribs is in a range of 5 mm to 100 mm.

In one implementation of the first aspect, a thickness of the rib is smaller than a thickness of each of the both side walls defining the hollow groove therebetween.

In one implementation of the first aspect, the rib has a thickness of 0.5 mm to 10 mm.

A second aspect of the present disclosure provides a roof rack for a vehicle, the roof rack comprising: a roof rail to be coupled to a vehicle body, wherein the roof rail has a hollow groove defined therein to extending in a longitudinal direction thereof, wherein a bottom of the roof rail is open and communicates with the hollow groove, wherein the bottom of the roof rail is coupled to the vehicle body, wherein the roof rail has both side walls defining the hollow groove therebetween, wherein the roof rail has a rib formed at the open bottom of the roof rail such that the rib connects the both side walls to each other; and a roof pad coupled to the bottom of the roof rail, wherein the roof pad is positioned between the vehicle body and the roof rail.

In one implementation of the second aspect, a roof pad coupling portion is formed in the rib, and a rib coupling portion corresponding to the roof pad coupling portion is formed on the roof pad.

In one implementation of the second aspect, the roof pad coupling portion is embodied as a protrusion receiving hole, and the rib coupling portion is embodied as a coupling protrusion inserted into the protrusion receiving hole.

In one implementation of the second aspect, the rib includes a plurality of ribs spacedly arranged at an equal spacing in the longitudinal direction, wherein the ribs partially cover the hollow groove.

In one implementation of the second aspect, a thickness of the rib is smaller than a thickness of each of the both side walls defining the hollow groove therebetween.

Specific details of other embodiments are included in the detailed description and the drawings.

### Technical Effect

In accordance with the present disclosure, the ribs are formed at the open bottom of the roof rail, such that the roof rail may be prevented from shrinking, and appearance quality defects caused by formation of a sink mark may be suppressed, and the roof rail has improved durability due to the ribs. Further, the roof pad coupling portion is defined in the rib of the roof rail to allow easy coupling of a roof pad to the roof rail.

It will be fully understood that embodiments of technical spirit of the present disclosure may provide various effects as not specifically mentioned.

### BRIEF DESCRIPTION OF DRAWINGS

FIG. 1 is a schematic diagram showing a vehicle equipped with a roof rack according to an embodiment of the present disclosure.

FIG. 2 is a schematic perspective view of a roof rack according to a first embodiment of the present disclosure.

FIG. 3 is a schematic bottom perspective view of the roof rack shown in FIG. 2.

FIG. 4 is a schematic exploded cross-sectional view of the roof rack shown in FIG. 2 as taken in a line A-A′.

FIG. 5 is a schematic cross-sectional view of a roof rack according to a second embodiment of the present disclosure.

FIG. 6 is a schematic partial bottom perspective view of a roof rail of the roof rack shown in FIG. 5.

FIG. 7 is a schematic cross-sectional view of the roof rack shown in FIG. 5.

### DETAILED DESCRIPTIONS

Advantages and features of the present disclosure, and methods of achieving them will be apparent with reference to embodiments as described below in detail in conjunction with the accompanying drawings. However, the present disclosure is not limited to the embodiments described herein and may be embodied in other forms. Rather, the embodiments introduced herein are provided to further convey the spirit of the present disclosure to those skilled in the art so that the disclosed contents may be thoroughly and completely understood by the skilled person to the art.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in detail with reference to the accompanying drawings.

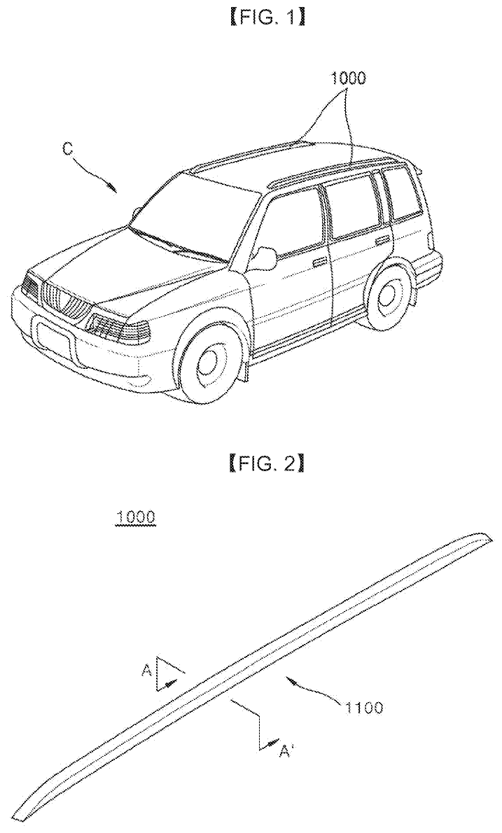

FIG. 1 is a schematic diagram showing a vehicle equipped with a roof rack according to an embodiment of the present disclosure.

As shown, a roof rack 1000 extending in a direction between front and rear wheels is mounted on a top of a body of a vehicle C.

Moreover, the roof rack 1000 has a fastener to fasten the rack to the vehicle body of the vehicle C such that the fastener is not exposed to an outside. Thus, not only the appearance quality of the rack is improved, but also the lifespan and durability of the fastener may be improved.

Further, a roof rail (1100 in FIG. 2) of the roof rack 1000 may be made of engineering plastic such as PP, PA6, ABS, PP+EPDM and PC+ABS. Further, the roof rail 1100 may be made of fiber reinforced plastic in consideration of light weight and durability.

Moreover, the fiber reinforced plastic is obtained by adding reinforcing fibers to a base resin. The base resin may include polyester resins, polyamide resins, nylon resins, and the like. Carbon fibers and/or glass fibers may be used as the reinforcing fibers.

Moreover, the fiber reinforced plastic may include glass fiber reinforced plastics, carbon fiber reinforced plastics, continuous fiber reinforced plastics, continuous glass fiber reinforced plastics, continuous carbon fiber reinforced plastics, short fiber reinforced plastics, short glass fiber reinforced plastic, short carbon fiber reinforced plastic, long fiber reinforced plastic, long glass fiber reinforced plastic, short glass fiber reinforced plastic and the like.

Hereinafter, detailed shape and configuration of the roof rack will be described in more detail with reference to FIGS. 2 to 4.

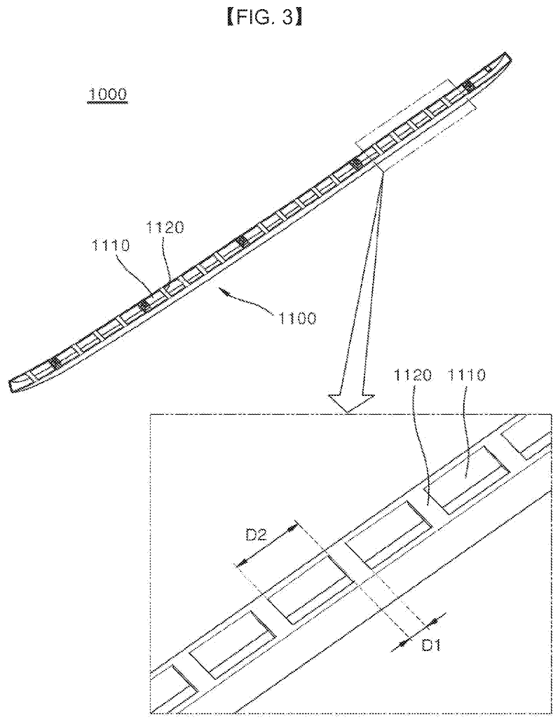

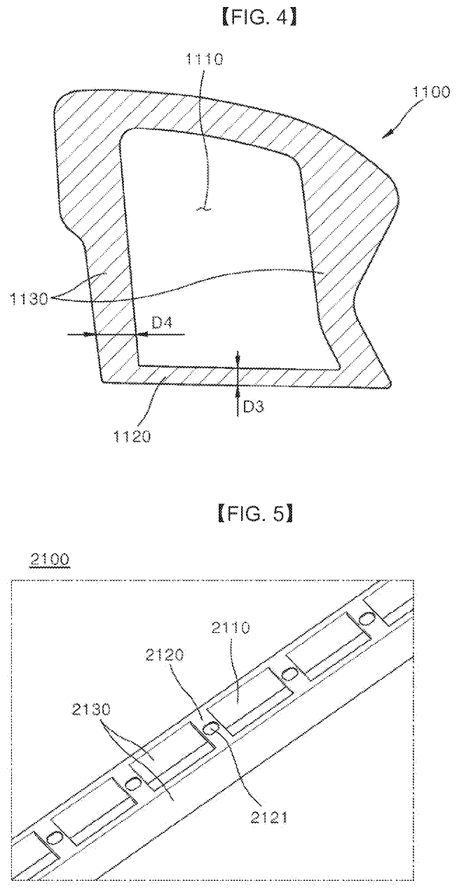

FIG. 2 is a schematic perspective view of a roof rack according to a first embodiment of the present disclosure. FIG. 3 is a schematic bottom perspective view of the roof rack shown in FIG. 2. FIG. 4 is a schematic exploded cross-sectional view of the roof rack shown in FIG. 2 taken in a line A-A′.

As shown, the roof rack 1000 includes the roof rail 1100. Moreover, the roof rail 1100 has a hollow groove 1110 defined therein, and ribs 1120.

More specifically, the hollow groove 1110 extends in a longitudinal direction of the roof rail 1100. Furthermore, the roof rail 1100 has an open bottom communicating with the hollow groove 1110. The roof rack is mounted, at the bottom thereof, onto the vehicle body.

That is, the roof rail 1100 has the both side walls 1130 defining the hollow groove 1110 therebetween when the roof rail 1100 is viewed in a cross-sectional manner.

Moreover, the hollow groove 1110 may be formed in the roof rail using a slide core mold.

Further, the ribs 1120 are formed at the open bottom of the roof rail 1100.

That is, the ribs 1120 connect the both side walls 1130 of the roof rail 1100 defining the hollow groove 1110 therebetween to each other.

Furthermore, as the plurality of ribs 1120 are spacedly arranged at an equal spacing in the longitudinal direction of the roof rail 1100. The hollow groove 1110 is partially covered by the ribs 1120.

In this case, as shown in FIG. 3, a width D1 of each rib 1120 may be in a range of 0.5 mm to 50 mm A spacing D2 between adjacent ribs 1120 may be in a range of 5 to 100 mm.

Conventionally, a roof rack according to a prior art is manufactured by high temperature extrusion molding of plastic for weight reduction, and thus is mounted on a vehicle. In this connection, there is a problem that bending or shape deformation due to shrinkage in the cooling process occurs, and a sink mark is formed. However, in accordance with the present disclosure, in order to prevent the bending of the roof rail due to the shrinkage, the plurality of ribs, each having a predetermined width, are arranged at a regular spacing. The width and the spacing have the optimal design values as defined above.

Further, as shown in FIG. 4, a thickness D3 of the rib 1120 may be smaller than a thickness D4 of each of the both side walls 1130 of the roof rail.

Further, the thickness D3 of the rib 1120 may be in a range of 0.5 mm to 10 mm.

Further, However, as each rib 1120 is formed at the open bottom, the sink mark may occur on an outer surface of the roof rail 100. However, a difference between cooling rates at the both side walls 1130 and each rib 1120 occurring due to a difference between the thickness of each of both side walls 1130 and the thickness of each rib 1120 may suppress the sink mark.

As described above, in the roof rack according to the first embodiment of the present disclosure, the plurality of ribs 1120 covering the open bottom of the roof rail 1100 and arranged at the equal spacing may allow the bottom thereof to be supported by the ribs 1120 to prevent shrinkage in the cooling process after injection molding. Thus, the occurrence of the sink mark may be inhibited.

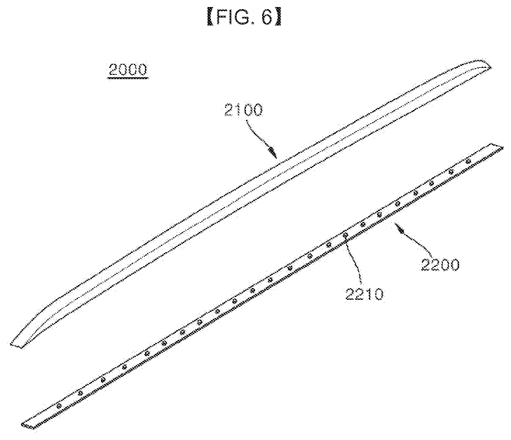

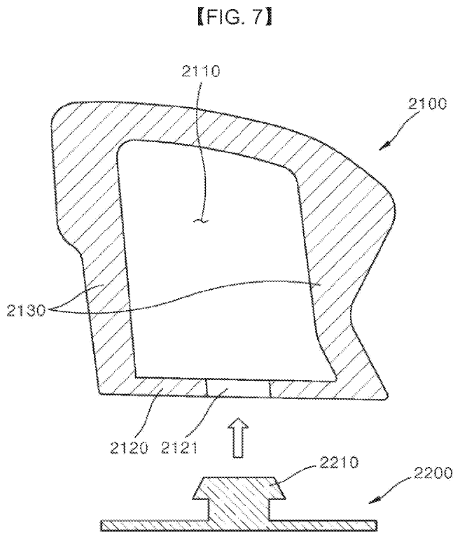

FIG. 5 is a schematic cross-sectional view of a roof rack according to a second embodiment of the present disclosure. FIG. 6 is a schematic partial bottom perspective view of a roof rail of the roof rack shown in FIG. 5. FIG. 7 is a schematic cross-sectional view of the roof rack shown in FIG. 5.

As shown, a roof rack 2000 in accordance with the second embodiment includes a roof rail 2100 and a roof pad 2200.

More specifically, the roof pad 2200 is coupled to a bottom of the roof rail 2100. The bottom of the roof rack 2000 is mounted on the vehicle body.

Moreover, the roof pad 2200 is located between the vehicle body and the roof rail 2100 to prevent friction between the roof rail 2100 and the vehicle body and corresponding noise and wear.

Further, the roof rail 2100 is different from the roof rail 1100 of the roof rack according to the first embodiment in terms of a roof pad coupling portion defined in the rib.

That is, the roof rail 2100 has a hollow groove 2110, ribs 2120 and both side walls 2130. Detailed shapes thereof and organic connection therebetween are as described above and thus are omitted.

In addition, a roof pad coupling portion is formed in each rib 2120. A rib coupling portion corresponding to the roof pad coupling portion is formed on the roof pad 2200.

FIG. 5 and FIG. 6 show an example in which a protrusion receiving hole 2121 as the roof pad coupling portion is formed in the rib 2120, and a coupling protrusion 2210 as the rib coupling portion is formed on the roof pad 2200.

Furthermore, the plurality of ribs 2120 are spacedly arranged at an equal spacing in the longitudinal direction of the roof rail 1100. A plurality of coupling protrusions 2210 are spacedly arranged at an equal spacing on the roof pad 2200 in a corresponding manner to the protrusion receiving holes 2121 defined in the ribs respectively.

Furthermore, as shown in FIG. 7, a corresponding coupling protrusion 2210 of the roof pad 2200 is inserted into a corresponding protrusion receiving hole 2121 defined in a corresponding rib 2120 of the roof rail 2100 as shown by an arrow. In this way, the roof rail 2100 and the roof pad 2200 may be combined easily and securely with each other.

As described above, as in the roof rack according to the first embodiment shown in FIG. 2, in the roof rack according to the second embodiment of the present disclosure, the bending or shape change of the rail due to the shrinkage may be prevented by the ribs. Further, the formation of the sink mark may be suppressed. The roof rail may be easily coupled to the roof pad, thereby to improve assembly performance and productivity of the roof rack.

The preferred embodiments of the present disclosure has been described with reference to the accompanying drawings. However, those skilled in the art will appreciate that the present disclosure may be embodied in other specific forms without changing technical spirit or essential characteristics thereof. Therefore, it should be understood that one embodiment described above is illustrative in all respects and not restrictive.

What is claimed is:

1. A roof rack for a vehicle, the roof rack comprising a roof rail to be coupled to a vehicle body,
wherein the roof rail has a hollow groove defined therein to extending in a longitudinal direction thereof, wherein a bottom of the roof rail is open and communicates with the hollow groove, wherein the bottom of the roof rail is coupled to the vehicle body,
wherein the roof rail has both side walls defining the hollow groove therebetween,
wherein the roof rail has a rib formed at the open bottom of the roof rail such that the rib connects the both side walls to each other.

2. The roof rack of claim 1, wherein the rib includes a plurality of ribs spacedly arranged at an equal spacing in the longitudinal direction, wherein the ribs partially cover the hollow groove.

3. The roof rack of claim 2, wherein a width of each rib is a range of 0.5 mm to 50 mm, wherein a spacing between adjacent ribs is in a range of 5 mm to 100 mm.

4. The roof rack of claim 1, wherein a thickness of the rib is smaller than a thickness of each of the both side walls defining the hollow groove therebetween.

5. The roof rack of claim 4, wherein the rib has a thickness of 0.5 mm to 10 mm.

6. A roof rack for a vehicle, the roof rack comprising:
a roof rail to be coupled to a vehicle body, wherein the roof rail has a hollow groove defined therein to extending in a longitudinal direction thereof, wherein a bottom of the roof rail is open and communicates with the hollow groove, wherein the bottom of the roof rail is coupled to the vehicle body, wherein the roof rail has both side walls defining the hollow groove therebetween, wherein the roof rail has a rib formed at the open bottom of the roof rail such that the rib connects the both side walls to each other; and
a roof pad coupled to the bottom of the roof rail, wherein the roof pad is positioned between the vehicle body and the roof rail.

7. The roof rack of claim 6, wherein a roof pad coupling portion is formed in the rib, and a rib coupling portion corresponding to the roof pad coupling portion is formed on the roof pad.

8. The roof rack of claim 7, wherein the roof pad coupling portion is embodied as a protrusion receiving hole, and the rib coupling portion is embodied as a coupling protrusion inserted into the protrusion receiving hole.

9. The roof rack of claim 6, wherein the rib includes a plurality of ribs spacedly arranged at an equal spacing in the longitudinal direction, wherein the ribs partially cover the hollow groove.

10. The roof rack of claim 6, wherein a thickness of the rib is smaller than a thickness of each of the both side walls defining the hollow groove therebetween.
